(19) United States
(12) Patent Application Publication
(10) Pub. No.: US 2025/0192235 A1
(43) Pub. Date: Jun. 12, 2025

(54) RESIN LAYERS OF A SOLID-STATE BATTERY WITH ANODE OVERHANG

(71) Applicant: FORD GLOBAL TECHNOLOGIES, LLC, Dearborn, MI (US)

(72) Inventors: Hyukkeun OH, Ann Arbor, MI (US); Ali RASHTI, Canton, MI (US); Xin LIU, Novi, MI (US)

(21) Appl. No.: 18/536,358

(22) Filed: Dec. 12, 2023

(51) Int. Cl. H01M 10/058; B33Y 10/00; H01M 10/0525; H01M 50/46

(52) U.S. Cl. CPC H01M 10/058; H01M 10/0525; H01M 50/46; B33Y 10/00

(57) ABSTRACT

A solid-state battery with a particular structure and methods for forming such are discussed. The solid-state battery comprises a compacted solid-state battery cell including a separator-anode laminate, a plurality of solid resin layers defining a cradle around and extending away from a perimeter of a separator side of the separator-anode laminate, and a cathode disposed within the cradle and in direct contact with the separator side such that adjacent exterior surfaces of the cradle and cathode are flush.

### TECHNICAL FIELD

This disclosure relates to cell structure for lithium-ion battery cells.

### BACKGROUND

In solid-state batteries, the application of pressure to constituent layers of the battery may help to increase their interlayer contact and conductivity, which may lead to better battery performance.

### SUMMARY

In one aspect a solid-state battery comprises a compacted solid-state battery cell including a separator-anode laminate, a plurality of solid resin layers defining a cradle around and extending away from a perimeter of a separator side of the separator-anode laminate, and a cathode disposed within the cradle and in direct contact with the separator side such that adjacent exterior surfaces of the cradle and the cathode are flush.

The solid-state battery may further comprise an electrical tab attached to an anode side of the separator-anode laminate. A separator portion of the separator-anode laminate may be sulfide-based. The anode portion of the separator-anode laminate may be silicon-based. The thickness of the cathode may be less than 40 μm. A modulus of elasticity of the solid resin layers may be within 10% of a modulus of elasticity of the cathode.

In another aspect a lithium-ion battery comprises a cathode, a separator laminated with an anode, and a solid resin cradle printed on the separator overlapped with the anode such that the cathode can be placed inside the solid resin cradle and compressed with the separator, anode, and solid resin layer to form a battery cell. The battery cell may further comprise an electrical tab connected to the anode extending from a side opposite the separator. The solid cradle may have a modulus of elasticity that is within 10% of that of the cathode. The solid resin layer may have either a thickness greater than a thickness of the cathode or a thickness less than the thickness of the cathode. The solid resin layer may be made of a thermosetting material. The separator may be porous polyethylene based. In other configurations the separator may be sulfide based and the anode may be silicon composite based.

In another aspect a method comprises printing a solid resin cradle around a perimeter of a separator side of a separator-anode laminate. Disposing a cathode on the separator side and within the solid resin cradle, and compressing the solid resin cradle, separator-anode laminate, and cathode such that adjacent exterior surfaces of the solid resin cradle and cathode are flush to form a compacted lithium-ion battery cell. In some configurations at least 400 megapascal (MPa) may be applied during the compression step.

### BRIEF DESCRIPTION OF THE DRAWINGS

FIG. 1A is a top-down view of a cathode-sized mask on an anode according to one embodiment;

FIG. 1B is a top-down view of a cathode-sized mask on a separator side of a separator-anode laminate according to one embodiment;

FIG. 1C is a top-down view of a plurality of resin layers on an assembly according to one embodiment;

FIG. 1D is a top-down view of a cathode with an assembly according to one embodiment;

FIG. 1E is a schematic cross-sectional view of the assembly of FIG. 1D along the V-V line according to one embodiment;

FIG. 1F is a schematic cross-sectional view of the compacted assembly of FIG. 1D along the V-V line after a compression step according to one embodiment; and

FIG. 2. is a flowchart of an assembly process according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Solid-state batteries in an anode overhang configuration, wherein the cathode is dimensionally smaller than the combined separator-anode laminate may have cracks on the solid-state separator, particularly around the edge of the cathode after the application of pressure. These cracks may be caused by the accumulation of stress at these points.

The proposed assembly process includes printing a solid resin around a cathode. This step is intended to distribute pressure more evenly during the compression phase. By selecting a resin of similar properties such as a modulus of elasticity to the cathode, the edge of the cathode is less likely to become a primary point of pressure, which can help mitigate crack formation. Even if the resin is not flush with the cathode, the presence of the resin adjacent to the cathode edge may help maintain a gap between the compressed cathode and an uncompressed anode. This spacing may reduce the likelihood of a short circuit.

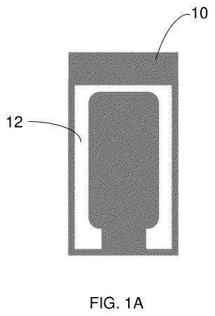

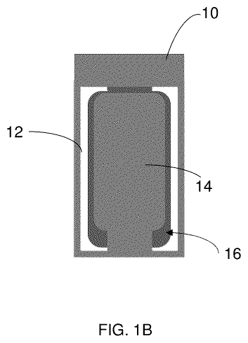

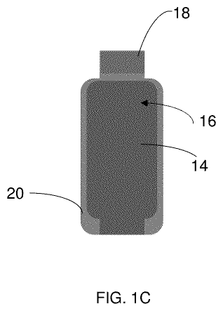

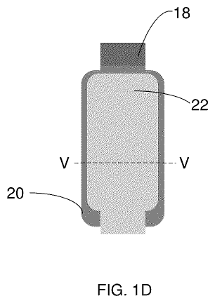

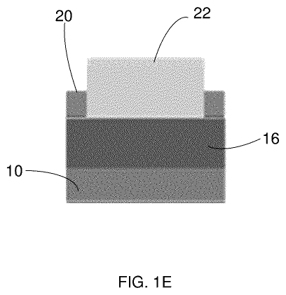

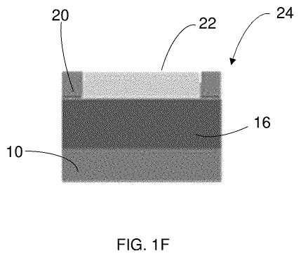

FIG. 1A illustrates a top-down view of a cathode-sized mask 12 on an anode 10. FIG. 1B illustrates a top-down view of a cathode-sized mask 12 on a separator side 14 of a separator-anode laminate 16 according to one embodiment. The separator-anode laminate 16 may be of various material compositions, including but not limited to a separator portion 14 that is sulfide-based and an anode portion 10 that may be silicon-based, providing increased ionic conductivity and energy capacity respectively. In some configurations the separator portion 14 may be porous polyethylene based. FIG. 1C shows a top-down view of a plurality of resin layers 20 on the separator side 14 of the separator-anode laminate 16 with an electrical tab 18. The electrical tab 18 may be attached to the anode side 10 of the separator-anode laminate 16, and extends from a side opposite the separator 14 to facilitate external electrical connection. The solid resin layers 20 may be printed on to the interior of the cathode-sized mask 12 in a way to form a solid resin cradle 20. The cradle 20 may extend away from a perimeter of the separator side 14 so as to receive a cathode. After the cradle 20 is formed the cathode-sized mask 12 may be removed.

FIG. 1D illustrates a top-down view of a cathode 22 placed within the resin cradle 20 forming battery cell 24. The cathode 22 is disposed within the cradle 20 in direct contact with the separator side 14 of the separator-anode laminate 16. The material selected for the solid resin layer 20 may be a thermosetting material. Additionally, the resin 20 may have a modulus of elasticity that is within 10% of that of the cathode 22. In other configurations the resin 20 may have a modulus of elasticity that is greater than the modulus of elasticity of the cathode 22. FIG. 1E illustrates a cross-sectional view of the lithium-ion battery cell 24 of FIG. 1D along the V-V line. FIG. 1F is a schematic cross-sectional view of the compacted lithium-ion battery cell 24 of FIG. 1D along the V-V line after a compression step. During the compression step, the cathode 22, separator-anode laminate 16, and the solid resin cradle 20 are compressed together, which may increase the interfacial contact and overall cohesion of the battery cell 24. After the compression step the cathode may have a thickness of less than 40 μm. The adjacent exterior surfaces of the cradle 20 and cathode 22 may be flush. In some configurations the thickness of the solid resin cradle 20 may be within 10%, greater than, or less than the thickness of the cathode 22.

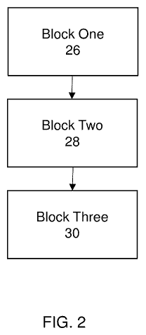

FIG. 2. shows a flowchart of an assembly process according to one embodiment. Starting with Block One 26, a solid resin cradle is printed around a perimeter of a separator side of a separator-anode laminate. The separator may be porous polyethylene based. In other configurations the separator may be sulfide based and the anode may be silicon composite based. An electrical tab may be attached to an anode side of the separator-anode laminate. The printing process may employ techniques such as 3D printing or screen printing. In Block Two 28, a cathode is disposed on the separator side and within the solid resin cradle. The materials used for the solid resin may have a modulus of elasticity within 10% of a modulus of elasticity of the cathode. In Block Three 30, the solid resin cradle, separator-anode laminate, and cathode are compressed such that adjacent exterior surfaces of the solid resin cradle and cathode are flush to form a compacted lithium-ion battery cell. The compression step of Block Three 30 may comprise at least 400 MPa of pressure to be applied.

The algorithms, methods, or processes disclosed or suggested herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A solid-state battery comprising:
a compacted solid-state battery cell including a separator-anode laminate, a plurality of solid resin layers defining a cradle around and extending away from a perimeter of a separator side of the separator-anode laminate, and a cathode disposed within the cradle and in direct contact with the separator side such that adjacent exterior surfaces of the cradle and cathode are flush.

2. The solid-state battery of claim 1 further comprising an electrical tab attached to an anode side of the separator-anode laminate.

3. The solid-state battery of claim 1, wherein a separator portion of the separator-anode laminate is sulfide-based.

4. The solid-state battery of claim 1, wherein an anode portion of the separator-anode laminate is silicon-based.

5. The solid-state battery of claim 1, wherein a thickness of the cathode is less than 40 μm.

6. The solid-state battery of claim 1, wherein a modulus of elasticity of the solid resin layers is within 10% of a modulus of elasticity of the cathode.

7. A lithium-ion battery comprising:
a cathode;
a separator and anode laminated together; and
a solid resin cradle printed on the separator and overlapped with the anode such that the cathode can be placed inside the solid resin cradle and compressed with the separator, anode, and solid resin cradle to form a battery cell.

8. The lithium-ion battery of claim 7, further comprising an electrical tab connected to the anode extending from a side opposite the separator.

9. The lithium-ion battery of claim 7, wherein the solid resin cradle has a modulus of elasticity within 10% of the modulus of elasticity of the cathode.

10. The lithium-ion battery of claim 7, wherein the solid resin cradle has a modulus of elasticity greater than the modulus of elasticity of the cathode.

11. The lithium-ion battery of claim 7, wherein the solid resin cradle has a modulus of elasticity less than the modulus of elasticity of the cathode.

12. The lithium-ion battery of claim 7, wherein the solid resin cradle has a thickness within 10% of a thickness of the cathode.

13. The lithium-ion battery of claim 7, wherein the solid resin cradle has a thickness greater than a thickness of the cathode.

14. The lithium-ion battery of claim 7, wherein the solid resin cradle has a thickness less than a thickness of the cathode.

15. The lithium-ion battery of claim 7, wherein the solid resin cradle is made of a thermosetting material.

16. The lithium-ion battery of claim 7, wherein the separator is porous polyethylene based.

17. The lithium-ion battery of claim 7, wherein the separator is sulfide based.

18. The lithium-ion battery of claim 7, wherein the anode is silicon composite based.

19. A method comprising:
printing a solid resin cradle around a perimeter of a separator side of a separator-anode laminate;
disposing a cathode on the separator side and within the solid resin cradle; and
compressing the solid resin cradle, separator-anode laminate, and cathode such that adjacent exterior surfaces of the solid resin cradle and cathode are flush to form a compacted lithium-ion battery cell.

20. The method of claim 19, wherein at least 400 MPa is applied during the compression of the solid resin cradle, separator-anode laminate, and cathode.
